(19) United States
(12) Patent Application Publication
(10) Pub. No.: US 2002/0085027 A1
(43) Pub. Date: Jul. 4, 2002

(54) Method for displaying advertisement using short message service in a portable mobile terminal

(75) Inventor: Hyung-Chul Kim, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/020,756

(22) Filed: Dec. 12, 2001

(30) Foreign Application Priority Data
Dec. 30, 2000 (KR) 87209/2000

(51) Int. Cl. G09G 5/00

(52) U.S. Cl. 345/738

(57) ABSTRACT

Disclosed is a method for displaying an advertisement using an SMS service in a portable mobile terminal. The method comprises accessing a web site server of an SMS-based advertisement service provider, to select a desired advertisement and a desired advertisement time and to input a phone number of the portable mobile terminal; receiving advertisement data of the selected advertisement and associated advertisement schedule from the web site server, through an SMS message; storing the received advertisement data in a memory in a predetermined advertisement data format; storing the received advertisement schedule data in the memory in a predetermined advertisement schedule data format; and displaying on a display of the portable mobile terminal the advertisement data according to the advertisement schedule data. Further, the portable mobile terminal returns to an initial screen after displaying the advertisement data for a time specified in the advertisement schedule data.

### PRIORITY

This application claims priority to an application entitled “Method for Displaying Advertisement Using Short Message Service in a Portable Mobile Terminal” filed in the Korean Industrial Property Office on Dec. 30, 2000 and assigned Serial No. 2000-87209, the contents of which are hereby incorporated by reference.

### BACKGROUND OF THE INVENTION

1. Field of the Invention

The present invention relates generally to a portable mobile terminal, and in particular, to a method for displaying advertisements on a display unit using a short message service (SMS).

2. Description of the Related Art

At present, an SMS service is chiefly used for providing a terminal user with various useful information such as news, traffic and stock information. In addition, the SMS service is also used for an exchange of short messages between the terminal users. Meanwhile, the portable mobile terminal includes an LCD (Liquid Crystal Display) panel to display its operating status and various information such as call terminating information and SMS messages, received from the other party and written by the user.

The advantage of the portable mobile terminal consists in the portability and the mobility. Thanks to the portability and the mobility, the user of the portable mobile terminal can be provided with desired information at a desired time or as soon as a certain event occurs, using the SMS service. For example, the terminal user can be provided with shopping information when purchasing merchandise and with travel information when traveling.

In the near future, an advanced advertisement method based on the portability and mobility of the portable mobile terminal may replace the existing unidirectional advertisement method based on the mass media such as newspaper and TV. In the advanced advertisement method, the user can select only the advertisements that he or she desires to see.

During the SMS service, the mobile communication system generally sends messages to the portable mobile terminal using a paging channel rather than a traffic channel. Therefore, an amount of transmission data is limited during the SMS service, but the portable mobile terminal can be provided with the messages even though it is not connected to the mobile communication system. Of course, in some cases, the portable mobile terminal can also send the SMS messages through the traffic channel rather than the paging channel. Herein, however, the latter case where the portable mobile terminal sends the SMS messages through the traffic channel will not be considered. In addition, the advantage of the advanced SMS-based advertisement method consists in sending an advertisement, e.g., shopping information, to a plurality of terminal users at the same time.

The SMS service can be divided into a point-to-point mode and a cell-broadcast (or point-to-omnipoint) mode. Here, the point-to-point mode is used for an exchange of messages between individuals, while the cell-broadcast mode is used for simultaneously sending various information such as news and traffic information to a plurality of terminal users staying in a given cell area. When used for the Internet, the SMS messages each comprised of 160 bytes are too short to deliver a great amount of information.

Meanwhile, the recent portable mobile terminal is designed to support the mobile Internet. In this case, upon access to the mobile Internet, the portable mobile terminal opens a specific initial web page (i.e., home page) and displays the contents of the home page on the display unit.

However, compared with the existing PC-based wire Internet, the mobile Internet based on the portable mobile terminal has a limitation in the screen size and thus, supports a different display format. In addition to such inconveniences, the user should pay an extra call fee when accessing the mobile Internet using the portable mobile terminal.

### SUMMARY OF THE INVENTION

It is, therefore, an object of the present invention to provide a method for receiving a desired advertisement together with its associated advertisement schedule using the SMS service and displaying the received advertisement according to the advertisement schedule in a portable mobile terminal.

To achieve the above and other objects, there is provided a method for displaying an advertisement using an SMS service in a portable mobile terminal. The method comprises accessing a web site server of an SMS-based advertisement service provider, to select a desired advertisement and a desired advertisement time and to input a phone number of the portable mobile terminal; receiving advertisement data of the selected advertisement and associated advertisement schedule from the web site server, through an SMS message; storing the received advertisement data in a memory in a predetermined advertisement data format; storing the received advertisement schedule data in the memory in a predetermined advertisement schedule data format; and displaying on a display of the portable mobile terminal the advertisement data according to the advertisement schedule data. Further, the portable mobile terminal returns to an initial screen after displaying the advertisement data for a time specified in the advertisement schedule data.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a mobile communication-based advertising system to which the present invention is applied;

FIG. 2 illustrates the portable mobile terminal shown in FIG. 1;

FIGS. 3A and 3B illustrate SMS message formats for advertisement data and advertisement schedule data according to an embodiment of the present invention, respectively;

FIG. 4A defines a data structure for storing an advertisement schedule according to an embodiment of the present invention;

FIG. 4B defines a data structure for storing advertisement images according to an embodiment of the present invention;

FIG. 4C defines parameters used in an advertisement display process according to an embodiment of the present invention;

FIG. 5 illustrates major software blocks by function used in a method for displaying advertisements using the SMS service according to an embodiment of the present invention;

FIG. 6 illustrates a process flow of an advertisement scheduler function block according to an embodiment of the present invention;

FIG. 7 illustrates a process flow of a display data build function block according to an embodiment of the present invention; and

FIG. 8 illustrates a process flow of a scheduler activation function block according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention with unnecessary detail.

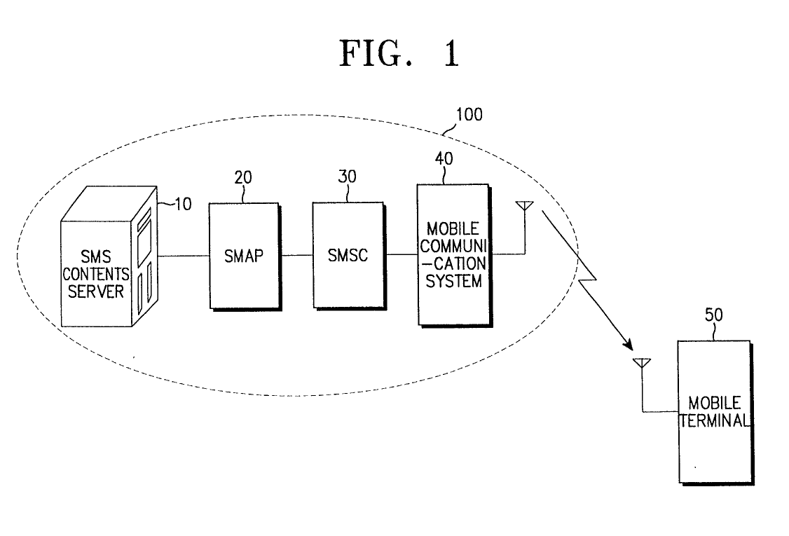

FIG. 1 illustrates a mobile communication-based advertising system to which the present invention is applied. As illustrated, the advertising system includes an SMS contents server 10 for providing web-based advertisements, an SMAP (Short Message Application Platform) 20, an SMSC (Short Message Service Center) 30, a mobile communication system 40, and a portable mobile terminal 50. The SMS contents server 10, the SMAP 20, the SMSC 30 and the mobile communication system 40 constitute an SMS-based advertisement service center 100, which transmits the SMS advertisement data and its associated advertisement schedule data, created by the SMS contents server 10, to the portable mobile terminal 50. In FIG. 1, the SMS contents server 10 is a web site server of an SMS-based advertisement service provider, having a database in which banner advertisement or logo advertisement information and associated advertisement schedule information are stored. The portable mobile terminal 50 supports a mobile Internet access function.

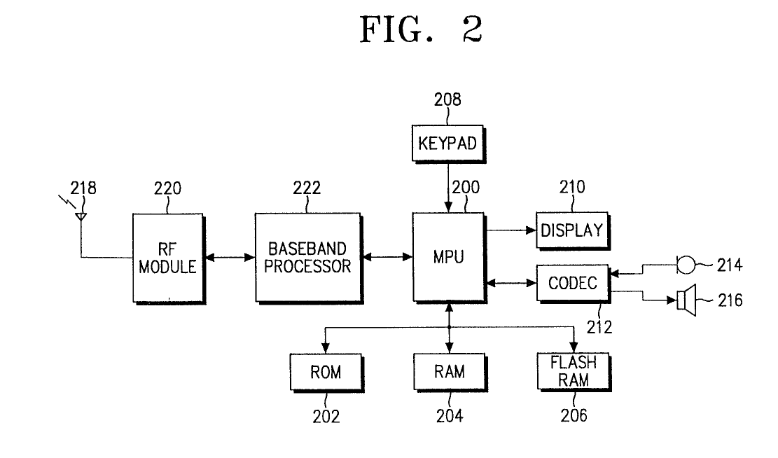

FIG. 2 illustrates a block diagram of the portable mobile terminal 50 supporting the mobile Internet access function. Referring to FIG. 2, a microprocessor unit (MPU) 200 is a block for processing and controlling a telephone call, a data call, and Internet access of the portable mobile terminal. In particular, the MPU 200 supports a service for downloading an SMS advertisement and displaying the downloaded SMS advertisement according to an embodiment of the present invention. A ROM (Read Only Memory) 202 stores micro codes of a control program for the MPU 200 and various reference data. A RAM (Random Access Memory) 204 serves as a working memory of the MPU 200. A flash RAM 206 stores various updatable data such as SMS advertisement data and SMS advertisement schedule data. A keypad 208 includes a plurality of alphanumeric keys and function keys, and provides the MPU 200 with key data corresponding to a key input by the user. A display unit 210 includes an LCD (Liquid Crystal Display), and displays image information on the LCD under the control of the MPU 200. In particular, the display unit 210 displays advertisement data according to the advertisement schedule data. A codec (coder-decoder) 212 connected to the MPU 200, and a microphone 214 and a speaker 216 connected to the codec 212, constitute an audio input/output block used for a telephone call and audio processing. In addition, an RF (Radio Frequency) module 220 transmits and receives an RF signal to/from a base station through an antenna 218. During transmission, the RF module 220 modulates an RF transmission signal received from the MPU 200 through a baseband processor 222 and transmits the modulated RF transmission signal through the antenna 218. During reception, the RF module 220 demodulates an RF signal received through the antenna 218 and provides the demodulated RF signal to the MPU 200 through the baseband processor 222. The baseband processor 222 processes the baseband signals exchanged between the RF module 220 and the MPU 200.

To receive the SMS advertisement service, the user accesses the SMS contents server 10 of the SMS-based advertisement service provider using the portable mobile terminal 50. Thereafter, the user selects the type and option of the desired SMS advertisement and then inputs a phone number of the portable mobile terminal 50. The SMS contents server 10 then inserts image information and schedule information of the selected advertisement in user data of the SMS message and sends the SMS message to the portable mobile terminal 50.

The SMS message format is comprised of a target address parameter indicating a phone number of a called party, a teleservice identifier (ID) parameter indicating a service type, a user data parameter, and a callback telephone number parameter indicating a telephone number for receiving a response to such as a calling party's number.

In general, the SMS advertisement data and the SMS advertisement schedule data are serviced using the teleservice ID parameter. When a specific teleservice ID parameter is transmitted, the teleservice is performed using the user data, the user destination address and the callback number.

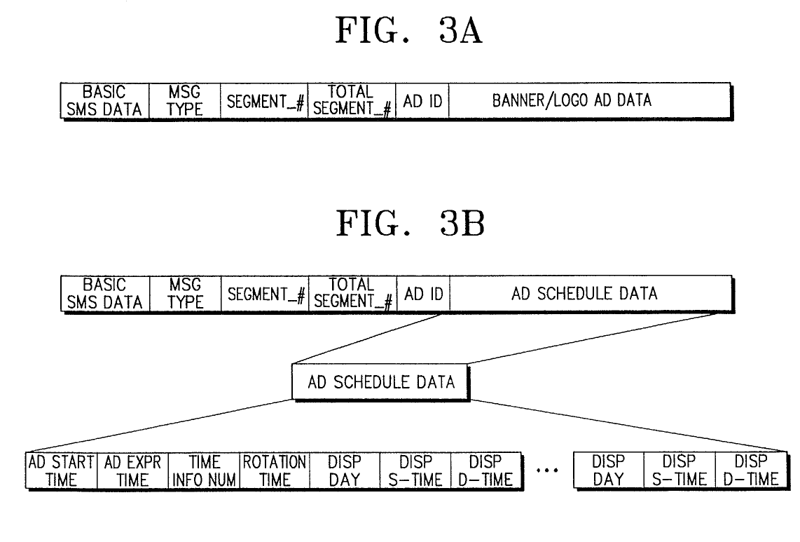

The SMS message transmitted from the SMS contents server 10 has a message format shown in FIGS. 3A and 3B. Specifically, FIG. 3A illustrates an SMS message format for the advertisement data, and FIG. 3B illustrates an SMS message format for the advertisement schedule data.

Referring to FIGS. 3A and 3B, the SMS message formats have the common data fields of a Basic SMS Data field, a Message Type field, a Segment_# field, a Total Segment_# field, and an Ad ID (Advertisement Identification) field. In addition, the SMS message format for the advertisement data, shown in FIG. 3A, includes a Banner/Logo Advertisement Data field, while the SMS message format for the advertisement schedule data, shown in FIG. 3B, includes an Advertisement Schedule Data field. The Message Type field indicates the type of the message filled in the Banner/Logo Advertisement Data field and the Advertisement Schedule Data field (i.e., indicates whether the message is an advertisement message or an advertisement schedule message). The Ad ID field is used for identification of the advertiser. The Ad ID field is also used as a medium for linking the advertisement data to the advertisement schedule data.

The advertisement data, if small in size, can be transmitted with one SMS message. However, when the advertisement data is too large in size to be transmitted with one SMS message, the data is segmented into several blocks. The segmented advertisement data blocks are transmitted using several SMS messages. To this end, the several leading bytes are used for the segment information. The Segment_# field and the Total Segment_# field constitute the segment information. Specifically, the Segment_# field indicates a currently received segment (or data block) number, i.e., indicates to which data block the current image advertisement data or the advertisement schedule data in the SMS message belongs. The Total Segment_# field indicates the total number of the blocks into which the image information or the schedule data of the advertisement data is segmented. In FIG. 3B, the Advertisement Schedule Data field includes a display schedule for the advertisement to be displayed. Fundamentally, the Advertisement Schedule Data field includes an Ad Start Time field, an Ad Expiration Time field, a Time Information Number field, a Rotation Time field, a Display Day field, a Display Start Time field, and a Display Duration Time field.

The structure of the Advertisement Schedule Data field shown in FIG. 3B will be described in more detail.

The Ad Start Time field indicates the time when an advertisement contracted with the advertiser starts. In this field is stored a value determined by converting year, month, date and hour to seconds.

The Ad Expiration Time field indicates the time when the advertisement contracted with the advertiser expires. In this field also is stored a value determined by converting year, month, date and hour to seconds.

The Time Information Number field indicates the number of time information sets, each comprised of Display Day, Display Start Time and Display Duration Time. For example, if an advertisement is scheduled to be displayed for one week at 1:30 p.m. on Monday, 4:50 p.m. on Monday, 11:10 a.m. on Wednesday, and 7:20 a.m. on Saturday, then the number of time information sets is 4. This value is variable according to the time information number in the received advertisement schedule data.

The Rotation Time field is used when several advertisements share the same display duration time. When several advertisements have the overlapped display duration time, the respective advertisements are displayed in rotation for the time duration (e.g., several seconds) defined in the Rotation Time field. When only one advertisement schedule exists in a linear list, the rotation time value is not used. This value is determined by converting (present time)+(rotation time) to seconds in the control program and the calculated value is stored in a RotTime parameter.

The Display Day field indicates the day when the advertisement is to be displayed. The Display Day field is set using the flags indicating Monday, Tuesday, Wednesday, Thursday, Friday, Saturday and Sunday.

The Display Start Time (DISP S-TIME) field indicates the time when the advertisement is to be displayed, and this value is converted to minutes. For example, if the advertisement is scheduled to be displayed at 1:30 p.m., this value becomes 13*60+30=810 minutes.

The Display Duration Time (DISP D-TIME) field indicates the time duration for which the advertisement is to be displayed, and this value is also converted to minutes. For example, if the advertisement is scheduled to be displayed at 1:30 p.m., the value becomes 13*60+30+(Display Duration Time). When the Display Duration Time is 2 minutes, this value becomes 13*60+30+2=812 minutes.

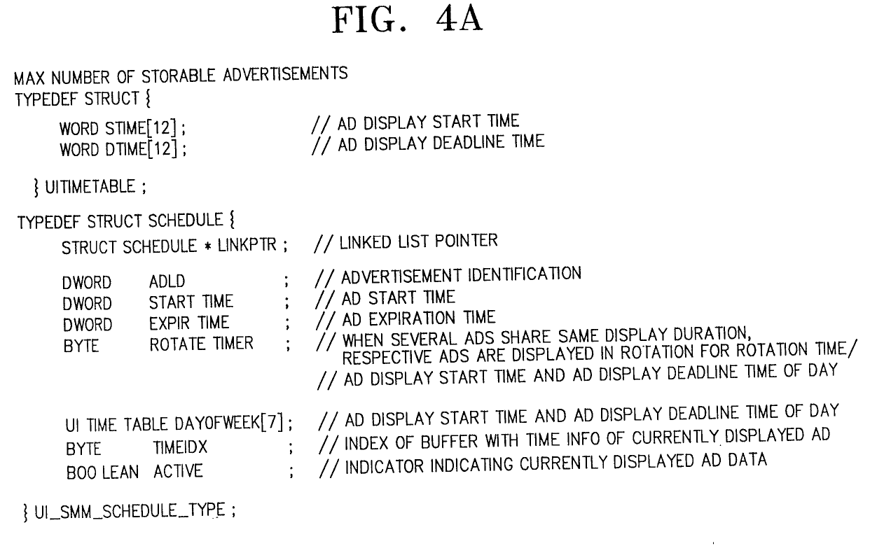

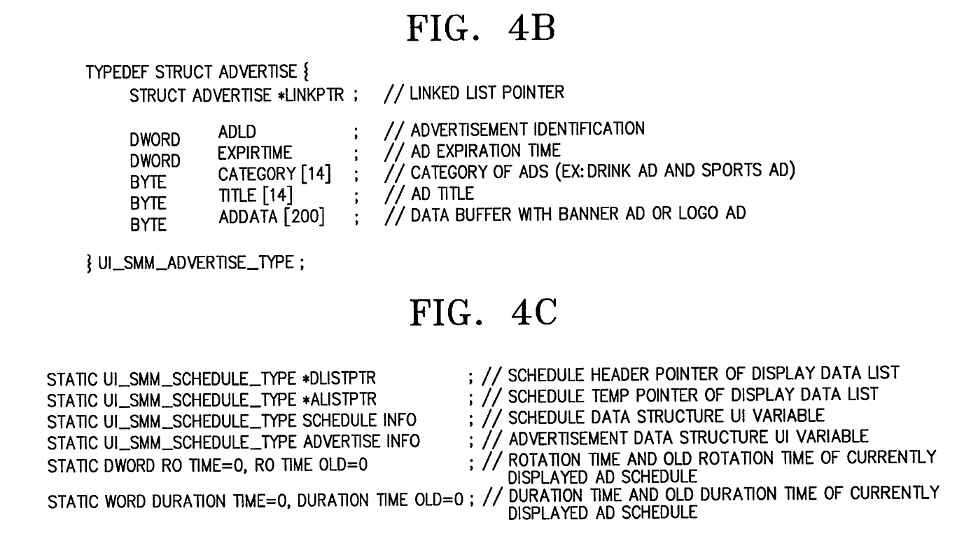

FIG. 4A defines a data structure for storing an advertisement schedule according to an embodiment of the present invention. Specifically, FIG. 4A defines the maximum number of advertisements which can be stored in the memory of the portable mobile terminal, the time information parameters required for displaying the advertisements, and the type of the parameters.

FIG. 4B defines a data structure for storing advertisement images according to an embodiment of the present invention. Specifically, FIG. 4B defines the parameters indicating the type, title and ID of the advertisements and the types of the parameters. In particular, FIG. 4B defines the structure of a pointer for pointing a list of the valid advertisements to be displayed and the structure of the data buffers.

FIG. 4C defines the parameters used in the advertisement display method according to an embodiment of the present invention. Specifically, FIG. 4C defines the parameters indicating the display start time and the display duration time of the advertisements.

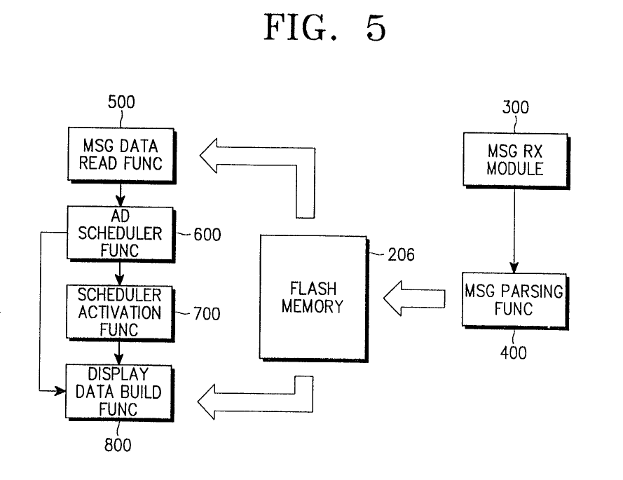

FIG. 5 illustrates major software blocks by function used in a method for displaying the advertisements using the SMS service according to an embodiment of the present invention. As illustrated, the major function blocks include a message parsing function block 400, a message data read function block 500, an advertisement scheduler function block 600, a scheduler activation function block 700 and a display data build function block 800.

Referring to FIG. 5, the message data read function block 500 reads advertisement data and time data, stored in the flash RAM 206, and stores the read data in the associated parameters. The message parsing function block 400 parses the advertisement image data and the advertisement schedule data of the SMS message, received from a message receiving module 300, and stores the parsed data in the associated memory parameters.

The advertisement scheduler function block 600 checks a rotation time and a duration time of the advertisement data structure inserted in the list of the valid advertisements to be displayed, and determines whether to display the advertisement or delete from the list the pointer of the data structure of the advertisement whose duration time has expired. When a specific condition is satisfied, the advertisement scheduler function block 600 sends an advertisement display command AD_DISP to the display data build function block 800.

The scheduler activation function block 700 reads the advertisement schedule data stored in the memory and inserts a pointer corresponding to the advertisement data that is to be immediately displayed into the linear list of the valid advertisements. In addition, the scheduler activation function block 700 deletes from the list the advertisement schedule data for which the display duration time has expired. At this point, the scheduler activation function block 700 checks the rotation time and the duration time of the inserted structure pointer of the advertisement schedule data to determine whether to perform the normal display or the rotation display. When a specific condition is satisfied, the scheduler activation function block 700 sends an advertisement insert command AD_INSERT or an advertisement delete command AD_DELTE to the display data build function block 800.

More specifically, when the time information data read from the memory satisfy the Ad Start Time, the Ad Expiration Time, the Display Day and the Display Start Time, an active flag is set to ‘True’ and the read data is inserted in the list. On the contrary, however, if the Ad Expiration Time has elapsed, the advertisement data and the associated time information are deleted from the memory. When the active flag is set to ‘True’, the time information data and the advertisement data are deleted from the list after a lapse of the Display Duration Time.

Upon receipt of the advertisement insert command AD_INSERT from the advertisement scheduler function block 600, the display data build function block 800 inserts the pointer of the advertisement image data having the image advertisement. On the contrary, upon receipt of the advertisement delete command AD_DELETE, the display data build function block 800 deletes a pointer of the advertisement image data structure having the advertisement image from the list. In addition, upon receipt of the advertisement display command AD_DISP, the display data build function block 800 displays the advertisement image data in the advertisement image data format on the LCD of the portable mobile terminal.

An operation of the present invention will be described in brief with reference to the software structure shown in FIG. 5.

First, the mobile communication service provider sends image data of the banner advertisement or logo advertisement contracted with the advertiser to the portable mobile terminal 50 through the SMS-based advertisement service center 100. When the data size is too large to be transmitted with one SMS message, the image data is segmented into several blocks. Further, the mobile communication service provider sends display schedule data of the advertisement through the SMS message to the portable mobile terminal 50, in the same manner as used in sending the banner advertisement or the logo advertisement.

The portable mobile terminal 50 then stores the received advertisement data and the advertisement schedule data in the flash RAM 206 in their associated data structures according to the present invention, under the control of the MPU 200.

Thereafter, the portable mobile terminal 50, under the control of the MPU 200, displays the banner advertisement or the logo advertisement on the LCD for a predetermined time at the time specified in the received advertisement schedule data, and then, returns to the initial screen after a lapse of the display duration time.

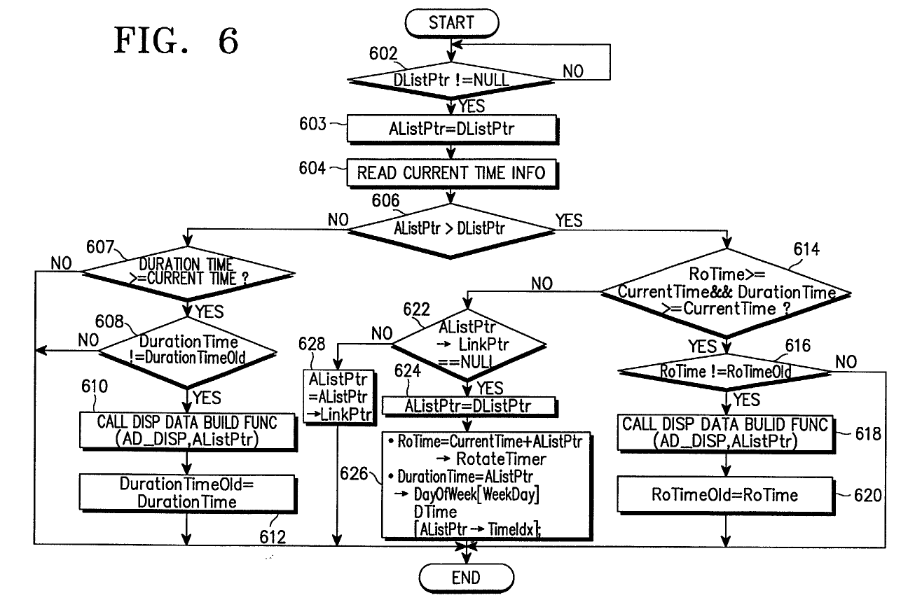

FIG. 6 illustrates a process flow of the advertisement scheduler function block 600 (FIG. 5) according to an embodiment of the present invention. The advertisement scheduler function block 600 checks a rotation time and a duration time pointed by the pointer of the advertisement data structure inserted in the list of the valid advertisements to be displayed, and determines whether to display the advertisement or delete from the list the pointer of the data structure of the advertisement whose duration time has expired. When a specific condition is satisfied, the advertisement scheduler function block 600 sends an advertisement display command AD_DISP to the display data build function block 800.

Referring to FIG. 6, the MPU 200 determines in step 602 whether a display list pointer (DListPtr) is not in a null state (DListPtr≠Null), thereby to judge whether there exists any advertisement data to be displayed in the current display list. If there exist one or more advertisements to be displayed, the MPU 200 copies the display list pointer DListPtr into an auxiliary (or temporary) list pointer (AListPtr) in step 603. Thereafter, the MPU 200 reads the current time information in step 604. The MPU 200 determines in step 606 whether there does not exist advertisement data to be displayed in the next display list (AListPtr≠Null), i.e., whether the number of the advertisements to be currently displayed is one or at least two.

If it is determined in step 606 that there exists only one advertisement to be currently displayed, the MPU 200 determines in step 607 whether the display duration time (DurationTime) is larger than or equal to the current time (DurationTime≧CurrentTime). If the display duration time DurationTime is larger than or equal to the current time, the MPU 200 determines in step 608 whether the display duration time DurationTime is not equal to an old display duration time DurationTimeOld (DurationTime≠DurationTimeOld). The MPU 200 checks the display duration time DurationTime every minute. For example, if the display duration time of a certain advertisement is 2 minutes and the current time is 10:00 a.m., then DurationTime=10:02 a.m. If it is determined in step 608 that the display duration time (DurationTime) is not equal to the old display duration time (DurationTimeOld), the MPU 200 calls (or loads) the display data build function block 800 by applying the advertisement display command AD_DISP and the auxiliary list pointer (AListPtr) in step 610. DurationTime and DurationTimeOld both have an initial value of ‘0’. Thereafter, the MPU 200 copies DurationTime into DurationTimeOld in step 612, thereby preventing the same advertisement from being continuously displayed.

However, if there exist two or more advertisements to be currently displayed in step 606, the MPU 200 determines in step 614 whether the rotation time (RoTime) of the advertisement to be currently displayed is larger than or equal to the current time (RoTime≧CurrentTime) and the duration time (DurationTime) is also larger than or equal to the current time (DurationTime≧CurrentTime). The rotation time (RoTime) is set such that when there exist two or more advertisements to be displayed, the respective advertisements are displayed in rotation for the set rotation time (RoTime). Therefore, the MPU 200 checks RoTime every second. For example, if the rotation time is 10 seconds and the current time is 11:00 a.m., then RoTime=11:00:10 a.m. If it is determined in step 614 that RoTime is larger than or equal to the current time and DurationTime is also larger than or equal to the current time, the MPU 200 proceeds to step 616: otherwise, the MPU 200 proceeds to step 622. In step 616, the MPU 200 determines whether RoTime≠RoTimeOld. If RoTime≠RoTimeOld, the MPU 200 calls the display data build function block 800 by applying the advertisement display command AD_DISP and the auxiliary list pointer AListPtr in step 618, and then, copies RoTime into RoTimeOld in step 620.

In step 622, however, the MPU 200 shifts the auxiliary list pointer (AListPtr) of the advertisement to the linked current display list pointer (LinkPtr) and then determines whether the resulting value is equal to a null value (LinkPtr=Null). If the resulting value is equal to the null value, the MPU 200 copies the current display list pointer (DListPrt) into the auxiliary list pointer (AListPtr) in step 624 and then, proceeds to step 626. Otherwise, if the resulting value is not equal to the null value in step 622, the MPU 200 shifts from the auxiliary list pointer (AListPtr) to the linked current display pointer (LinkPtr) and then copies this into the auxiliary list pointer (AListPtr) in step 628. In step 626, the MPU 200 updates RoTime and DurationTime as shown in FIG. 6.

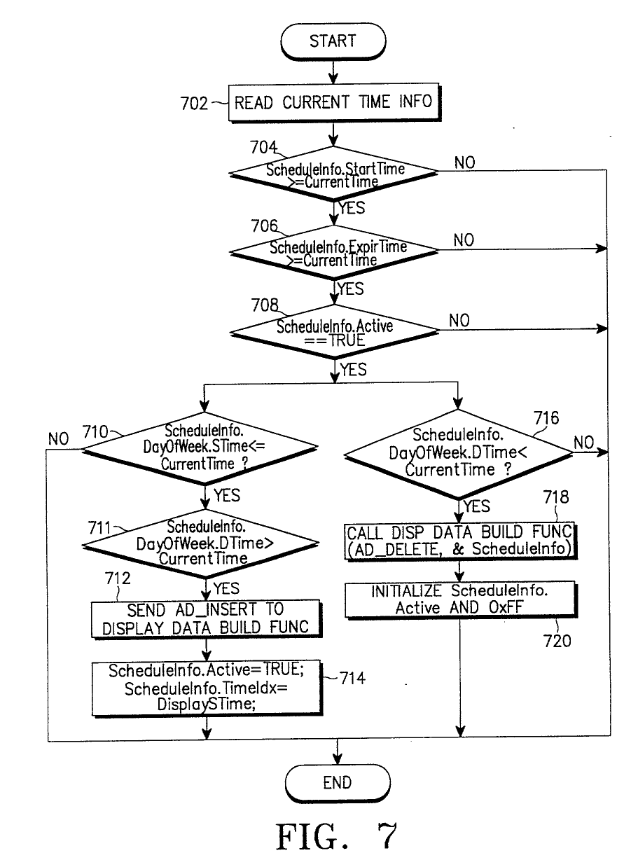

FIG. 7 illustrates a process flow of the scheduler activation function block 700 (FIG. 5) according to an embodiment of the present invention. The scheduler activation function block 700 reads the advertisement schedule data stored in the memory and inserts a pointer of the advertisement data to be immediately displayed into the list of the valid advertisements. In addition, the scheduler activation function block 700 deletes from the list the structure pointer of the advertisement schedule data, the display duration time of which has expired. At this point, the scheduler activation function block 700 checks the rotation time and the duration time of the inserted structure pointer of the advertisement schedule data, to determine whether to perform the normal display or the rotation display. When a specific condition is satisfied, the scheduler activation function block 700 sends an advertisement insert command AD_INSERT or an advertisement delete command AD_DELTE to the display data build function block 800 (FIG. 5).

Referring to FIG. 7, the MPU 200 reads the current time information in step 702, and then, determines in step 704 whether the advertisement start time (ScheduleInfo.StartTime) is larger than or equal to the current time (ScheduleInfo.StartTime≧CurrentTime). If the advertisement start time ScheduleInfo.StartTime is larger than or equal to the current time, the MPU 200 determines in step 706 whether the advertisement expiration time (ScheduleInfo.ExpirTime) is larger than or equal to the current time (ScheduleInfo.ExpirTime≧CurrentTime). That is, the MPU 200 determines in steps 704 and 706 whether the advertisement display time has come. Thereafter, the MPU 200 determines in step 708 whether the active flag value (ScheduleInfo.Active) is identical to ‘True’ (ScheduleInfo.Active=True), thereby to judge whether the advertisement data to be displayed is identical to the currently displayed advertisement data.

If it is determined in step 708 that the active flag value (ScheduleInfo.Active) is ‘True’, the MPU 200 proceeds to steps 710 and 716. Otherwise, if the active flag value (ScheduleInfo.Active) is not ‘True’, the MPU 200 ends the process. In step 710, the MPU 200 determines whether the advertisement display start time of the day (ScheduleInfo.DayOfWeek.Stime) has not yet arrived at the current time (ScheduleInfo.DayOfWeek.Stime≦current time). If the advertisement display start time of the day (ScheduleInfo.DayOfWeek.Stime) has not yet arrived at the current time, the MPU 200 determines in step 711 whether the advertisement display deadline time (ScheduleInfo.DayOfWeek.Dtime) has elapsed (ScheduleInfo.DayOfWeek.Dtime>CurrentTime). If the advertisement display deadline time has not elapsed, the MPU 200 proceeds to step 712.

In step 716, however, the MPU 200 determines whether the advertisement display deadline time of the day (ScheduleInfo.DayOfWeek.Dtime) has elapsed (ScheduleInfo.DayOfWeek.Dtime>CurrentTime). If the advertisement display deadline time of the day (ScheduleInfo.DayOfWeek.Dtime) has elapsed in step 716, the MPU 200 calls the display data build function block 800 by applying an advertisement schedule delete command AD_DELETE & ScheduleInfo in step 718. Thereafter, in step 720, the MPU 200 initializes the active flag value (ScheduleInfo.Active) and an index 0×FF of the buffer in which the time information of the currently displayed advertisement is registered. Here, the value 0×FF is 256 which is the maximum value which can be expressed with one byte (=8 bits).

In step 712, the MPU 200 executes the advertisement insert command AD_INSERT by calling the display data build function block 800. Thereafter, in step 714, the MPU 200 sets the active flag value ScheduleInfo.Active to ‘True’ to indicate that the advertisement is currently displayed, and then, sets the index of the buffer in which the time information of the advertisement is registered to the display start time of the current advertisement.

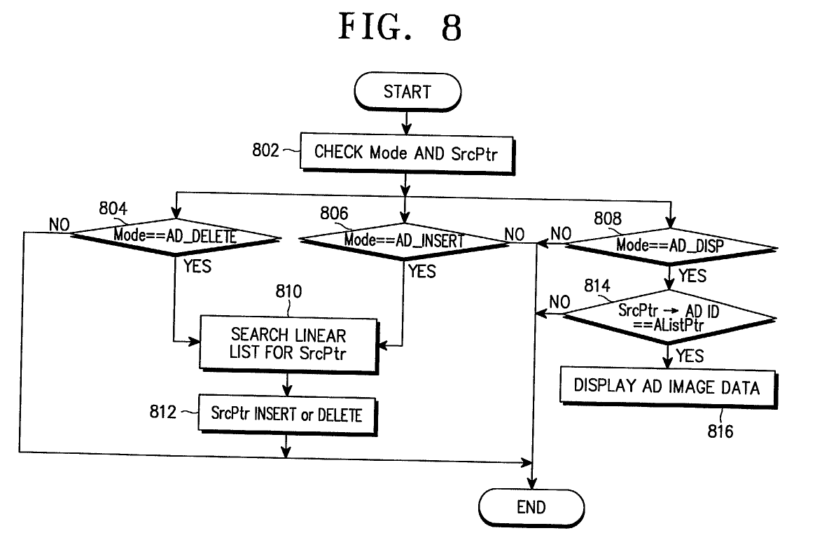

FIG. 8 illustrates a process flow of the display data build function block 800 (FIG. 5) according to an embodiment of the present invention. Upon receipt of the advertisement insert command (AD_INSERT) from the advertisement scheduler function block 600 (FIG. 5), the display data build function block 800 inserts in the linear list the pointer of the advertisement image data having the image advertisement. On the contrary, upon receipt of the advertisement delete command (AD_DELETE), the display data build function block 800 deletes the pointer of the advertisement image data structure having the advertisement image from the linear list. In addition, upon receipt of the advertisement display command (AD_DISP), the display data build function block 800 displays the advertisement image data in the advertisement image data format on the LCD of the portable mobile terminal.

Referring to FIG. 8, the MPU 200 checks a parameter mode (Mode) and a schedule data structure pointer (SrcPtr), received from the advertisement scheduler function block 600 (FIG. 5) and/or the scheduler activation function block 700 (FIG. 5), in step 802. Here, the parameter mode includes AD_DISP, AD_INSERT and AD_DELETE.

The MPU 200 proceeds from step 802 to a selected one of steps 804, 806 and 808, according to the parameter mode received in step 802. If the received parameter mode is equal to AD_DELETE or AD_INSERT in step 804 or 806, the MPU 200 searches the linear list for the schedule data structure pointer (SrcPtr) in step 810. Thereafter, in step 812, the MPU 200 inserts or deletes the schedule data structure pointer SrcPtr.

If the received parameter mode is equal to AD_DISP, the MPU 200 proceeds from step 808 to step 814. In step 814, the MPU 200 shifts the schedule data structure pointer SrcPtr to Ad ID and then, determines whether the resulting value is equal to the auxiliary list pointer (AListPtr). If the resulting value is equal to the auxiliary list pointer (AListPtr), the MPU 200 displays the corresponding advertisement image data on the LCD of the portable mobile terminal in step 816.

Therefore, the user can download the advertisements using the SMS service with the reduced call fee. In addition, when the advertisement data and the advertisement schedule data are too large in size to be transmitted with one SMS message, the data is transmitted after being segmented into several segments, so that the portable mobile terminal can download the data using several SMS messages. Therefore, the portable mobile terminal downloads the advertisement data together with the associated advertisement schedule data, and automatically displays the advertisement according to the advertisement schedule, so that the user can be benefited by reduction in the call fee by seeing the advertisements.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for reducing a call fee by improving the efficiency of mobile communication by utilizing a short message service (SMS) in a portable mobile terminal to display an advertisement, comprising the steps of:
receiving and storing advertisement data and advertisement schedule data from an SMS-based advertisement service provider; and
displaying on a portable mobile terminal the advertisement data according to the advertisement schedule data.

2. The method as claimed in claim 1, further comprising the steps of:
accessing a server of the SMS-based advertisement service provider to select a desired advertisement and a desired advertisement time; and
sending a phone number of the portable mobile terminal to the server for subscribing the SMS advertisement service.

3. The method as claimed in claim 1, wherein an SMS message includes an advertisement identifier (Ad ID) indicating that the SMS message is an advertisement message.

4. The method as claimed in claim 1, wherein the advertisement schedule data comprises:
start time information of the advertisement;
expiration time information of the advertisement; and
display day information of the advertisement.

5. The method as claimed in claim 4, wherein the advertisement schedule data further comprises:
rotation time information of the advertisement; and
display duration time information of the advertisement.

6. A method for providing an advertisement using an SMS service in a portable mobile terminal, comprising the steps of:
accessing a server of an SMS-based advertisement service provider to select at least one desired advertisement and at least one desired advertisement time and to input a phone number of the portable mobile terminal for receiving data related to a selected advertisement;
receiving the selected advertisement data and an associated advertisement schedule from the server;
storing the received advertisement data in a memory of the portable mobile terminal in a predetermined advertisement data format; and
storing the received advertisement schedule data in the memory in a predetermined advertisement schedule data format.

7. The method as claimed in claim 6, further comprising:
displaying the selected advertisement data according to the advertisement schedule data; and
returning to an initial screen mode after displaying the advertisement for a specified time according to the advertisement schedule data.

8. The method as claimed in claim 6, where the advertisement schedule data comprises start and expiration day information for the advertisement, display day information for the advertisement, and display duration time information for the advertisement.

9. The method as claimed in claim 8, further comprising a rotation time information for the advertisement schedule data if the selected advertisement time overlaps with at least one other selected advertisement time.

10. The method as claimed in claim 9, further comprising the step of alternatively displaying at least two advertisements in rotation according to the rotation time information.

11. A method for displaying an advertisement using an SMS service in a portable mobile terminal, comprising the steps of:
(a) checking an advertisement identifier (Ad ID) of a received message to determine whether the received message is an advertisement message;
(b) parsing, if the received message is found to be an advertisement message, advertisement data from advertisement schedule data and storing the parsed advertisement data and advertisement schedule data in a memory;
(c) utilizing the stored advertisement schedule data to determine whether to insert scheduled advertisement data into a display list;
(d) checking the advertisement schedule data to determine whether to delete expired advertisement data from the display list; and
(e) determining and displaying the advertisement data in the display list according to the advertisement schedule data.
